(19) United States
(12) Patent Application Publication
(10) Pub. No.: US 2026/0155538 A1
(43) Pub. Date: Jun. 4, 2026

(54) SECONDARY BATTERY

(71) Applicant: MURATA MANUFACTURING CO., LTD., Kyoto (JP)

(72) Inventor: Yoko ENDO, Kyoto (JP)

(21) Appl. No.: 19/370,160

(22) Filed: Oct. 27, 2025

(30) Foreign Application Priority Data
Dec. 3, 2024 (JP) 2024-210802

(51) Int. Cl. H01M 50/533; H01M 10/0587; H01M 50/538; H01M 50/593; H01M 50/595

(52) U.S. Cl. CPC H01M 50/533; H01M 10/0587; H01M 50/538; H01M 50/593; H01M 50/595

(57) ABSTRACT

A secondary battery is provided and including a wound body including a positive electrode and a negative electrode includes a positive electrode tab and a protective tape. The positive electrode tab includes a tab root portion disposed on a positive electrode current collector and a tab projecting portion projecting from the wound body. The protective tape includes a tape root portion covering the tab root portion and the positive electrode current collector, and a tape projecting portion projecting from the wound body. The tape projecting portion has a first partial projecting portion covering the tab projecting portion and a plurality of second partial projecting portions not covering the tab projecting portion. The tab projecting portion, the first partial projecting portion, and the plurality of second partial projecting portions are bent.

### CROSS REFERENCE TO RELATED APPLICATIONS

The present application claims priority to Japanese patent application no. 2024-210802, filed on Dec. 3, 2024, the entire contents of which are incorporated herein by reference.

### BACKGROUND

The present disclosure relates to a secondary battery.

As an example of a secondary battery, a secondary battery including a wound body in which electrodes including a positive electrode and a negative electrode are stacked and wound, an exterior body in which the wound body is housed, a positive electrode tab electrically connecting the positive electrode and the exterior body, and a protective tape covering the positive electrode tab.

### SUMMARY

The present disclosure relates to a secondary battery.

In the wound body, since the positive electrode tab is sandwiched between two electrodes adjacent to each other in a radial direction of the wound body, a gap may be formed in the vicinity of the positive electrode tab. When foreign matter is mixed into the gap, a short circuit may occur inside the wound body, and a voltage drop of the secondary battery may be caused.

The present disclosure, in an embodiment, relates to suppressing a voltage drop due to foreign matter mixing in a secondary battery including a wound body including a positive electrode and a negative electrode.

A secondary battery of the present disclosure, in an embodiment, includes: a wound body in which a positive electrode having a positive electrode current collector and a negative electrode are stacked and wound; an exterior body in which the wound body is housed; a positive electrode tab electrically connecting the positive electrode current collector and the exterior body to each other; and a protective tape attached to the positive electrode so as to cover the positive electrode tab, in which the positive electrode tab includes: a tab root portion disposed on the positive electrode current collector; and a tab projecting portion continuous from the tab root portion and projecting from the wound body, the protective tape includes: a tape root portion covering the tab root portion and the positive electrode current collector; and a tape projecting portion continuous from the tape root portion and projecting from the wound body, the tape projecting portion includes: a first partial projecting portion extending in a longitudinal direction of the tab projecting portion and covering the tab projecting portion; and a plurality of second partial projecting portions extending in the longitudinal direction of the tab projecting portion and not covering the tab projecting portion, and the tab projecting portion, the first partial projecting portion, and the plurality of second partial projecting portions are bent.

According to the secondary battery of the present disclosure, in an embodiment, it is possible to suppress a voltage drop due to foreign matter mixing.

### BRIEF DESCRIPTION OF THE FIGURES

FIG. 1 is a sectional view of a secondary battery according to an embodiment of the present disclosure;

FIG. 2 is a top view of a wound body illustrated in FIG. 1;

FIG. 3 is a plan view of a positive electrode included in the wound body illustrated in FIG. 2;

FIG. 4 is a sectional view of the positive electrode taken along line IV-IV illustrated in FIG. 3;

FIG. 5 is a plan view of the positive electrode to which a protective tape having a tape projecting portion is attached before a positive electrode tab, a first partial projecting portion, and a plurality of second partial projecting portions are formed;

FIG. 6 is a perspective view of the wound body showing a state where the positive electrode tab, the first partial projecting portion, and the plurality of second partial projecting portions are not bent;

FIG. 7 is a perspective view of the wound body included in the secondary battery according to Comparative Example 1;

FIG. 8 is a perspective view of the wound body included in the secondary battery according to Comparative Example 2;

FIG. 9 is a top view of the wound body included in the secondary battery according to Comparative Example 3;

FIG. 10 is a plan view of the positive electrode included in the wound body illustrated in FIG. 9;

FIG. 11 is a sectional view of the positive electrode taken along line X-X illustrated in FIG. 10;

FIG. 12 is a top view of the wound body included in the secondary battery according to an embodiment of the present disclosure;

FIG. 13 is a plan view of the positive electrode included in the wound body illustrated in FIG. 12;

FIG. 14 is a top view of the wound body included in the secondary battery according to an embodiment of the present disclosure;

FIG. 15 is a plan view of the positive electrode included in the wound body illustrated in FIG. 14;

FIG. 16 is a top view of the wound body included in the secondary battery according to an embodiment of the present disclosure;

FIG. 17 is an enlarged side view of a portion of the wound body illustrated in FIG. 16;

FIG. 18 is a sectional view of the positive electrode included in the secondary battery according to an embodiment of the present disclosure;

FIG. 19 is a plan view of the positive electrode included in the secondary battery according to an embodiment of the present disclosure; and

FIG. 20 is a top view of the wound body included in the secondary battery according to an embodiment of the present disclosure.

### DETAILED DESCRIPTION

Hereinafter, the present disclosure will be described in further detail including with reference to the drawings according to an embodiment. Note that the present disclosure is not limited thereby. Various elements in the drawings are merely schematically and exemplarily illustrated for understanding of the present disclosure, and appearance, dimensional ratios, and the like can be different from actual ones. Each embodiment is an example, and it goes without saying that partial substitution or combination of the configurations shown in the different embodiments can be made.

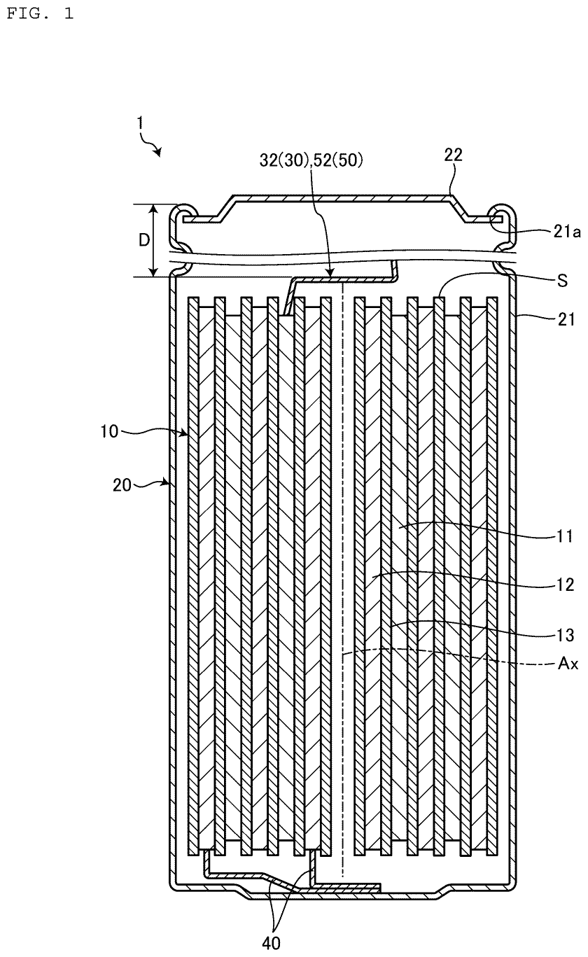

FIG. 1 is a sectional view of a secondary battery 1 according to a first embodiment of the present disclosure.

The secondary battery 1 is, for example, a lithium ion secondary battery. The secondary battery 1 includes a wound body 10, an exterior body 20, a positive electrode tab 30, a negative electrode tab 40, and a protective tape 50.

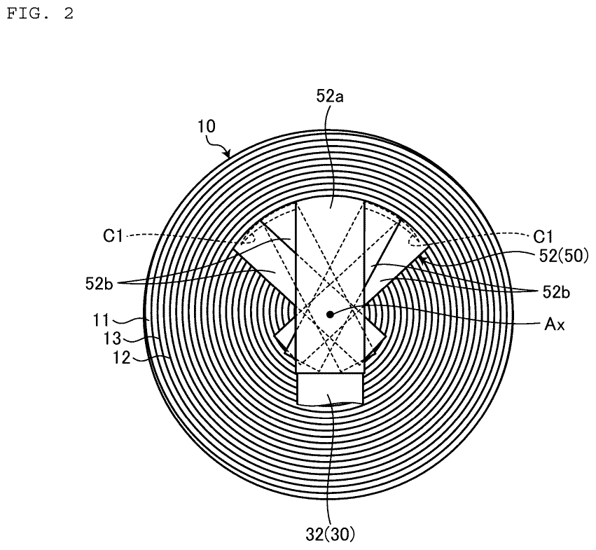

FIG. 2 is a top view of the wound body 10 illustrated in FIG. 1.

As illustrated in FIGS. 1 and 2, the wound body 10 is a cylindrical electrode body. The wound body 10 includes a positive electrode 11, a negative electrode 12, and a separator 13. In the wound body 10, a sheet-like positive electrode 11 and a sheet-like negative electrode 12 are stacked with the separator 13 interposed therebetween, and are wound around a central axis Ax. The wound body 10 has an end surface S facing a lid portion 22 described later. In the present specification, the end surface S corresponds to an upper surface of the wound body 10. The end surface S has irregularities.

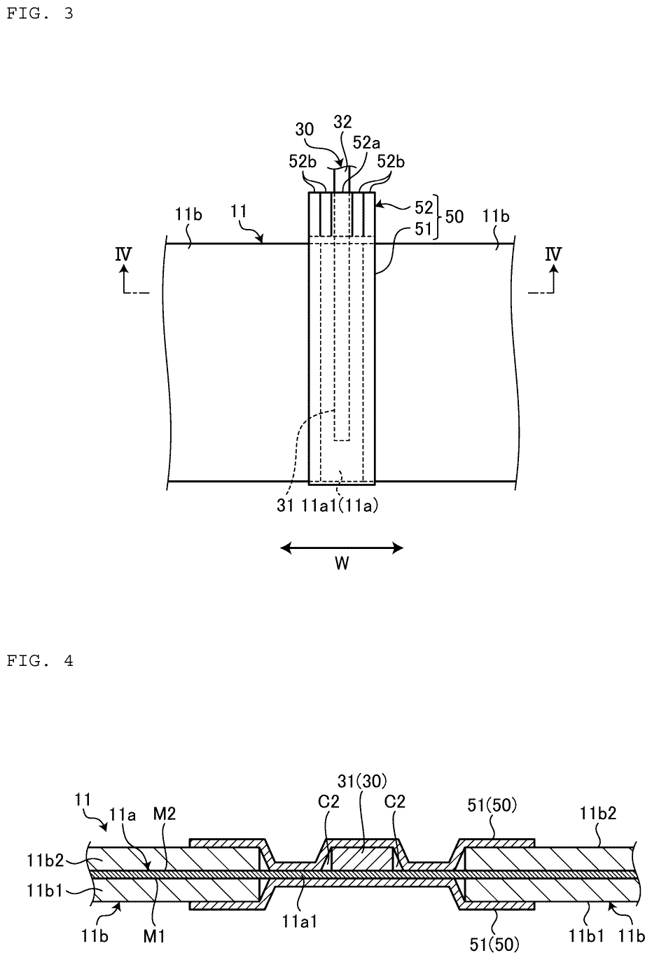

FIG. 3 is a plan view of the positive electrode 11 included in the wound body 10 illustrated in FIG. 2. The positive electrode 11 illustrated in FIG. 3 is in a flat state. An arrow illustrated in FIG. 3 is a winding direction W in which the positive electrode 11 is wound. FIG. 4 is a sectional view of the positive electrode 11 taken along line IV-IV illustrated in FIG. 3.

The positive electrode 11 has a rectangular shape in plan view with the winding direction W as a longitudinal direction. The positive electrode 11 includes a positive electrode current collector 11a and a positive electrode mixture layer 11b.

The positive electrode current collector 11a has a sheet shape having conductivity. A material of the positive electrode current collector 11a is, for example, metal, specifically, aluminum or the like. The positive electrode current collector 11a has an inner surface M1 on a radially inner side of the wound body 10 and an outer surface M2 on a radially outer side of the wound body 10. The positive electrode current collector 11a includes an exposed portion 11a1 where the positive electrode mixture layer 11b is not disposed.

The positive electrode mixture layer 11b has a sheet shape containing a positive electrode active material. The positive electrode mixture layer 11b includes a first positive electrode mixture layer 11b1 and a second positive electrode mixture layer 11b2. The first positive electrode mixture layer 11b1 is disposed on the inner surface M1 of the positive electrode current collector 11a. The second positive electrode mixture layer 11b2 is disposed on the outer surface M2 of the positive electrode current collector 11a. That is, the first positive electrode mixture layer 11b1 and the second positive electrode mixture layer 11b2 are arranged on opposite sides to each other with the positive electrode current collector 11a interposed therebetween.

The first positive electrode mixture layer 11b1 and the second positive electrode mixture layer 11b2 are respectively arranged on opposite sides to each other with the exposed portion 11a1 of the positive electrode current collector 11a interposed therebetween. Thus, the exposed portion 11al of the positive electrode current collector 11a is separated from an end portion of the positive electrode current collector 11a in the winding direction W.

The positive electrode active material is, for example, a metal oxide containing a lithium ion, specifically, lithium cobalt oxide, lithium nickel oxide, or the like.

The negative electrode 12 illustrated in FIG. 1 includes a sheet-like negative electrode current collector and a negative electrode mixture layer disposed on the negative electrode current collector and containing a negative electrode active material. The negative electrode active material is, for example, a carbon-containing material, a silicon-containing material, or a metal-containing material, and is specifically graphite, silicon oxide, or the like.

The separator 13 has a sheet shape sandwiched between the positive electrode 11 and the negative electrode 12, and electrically insulates the positive electrode 11 and the negative electrode 12 from each other.

The exterior body 20 houses the wound body 10. Further, an electrolyte is housed in the exterior body 20. The electrolyte is, for example, a nonaqueous electrolytic solution containing a lithium salt. The exterior body 20 includes a main body 21 and the lid portion 22.

A material of the main body 21 and the lid portion 22 has conductivity, and is, for example, iron, stainless steel, aluminum, or the like. The main body 21 has a tubular shape having an opening 21a on one end side thereof. The lid portion 22 covers the opening 21a of the main body 21. The lid portion 22 is disposed on the main body 21 in a state of being electrically insulated from the main body 21.

The positive electrode tab 30 electrically connects the positive electrode current collector 11a and the exterior body 20 to each other. As illustrated in FIGS. 3 and 4, the positive electrode tab 30 is disposed on the exposed portion 11al of the positive electrode current collector 11a in a state of being separated from the positive electrode mixture layer 11b.

The positive electrode tab 30 is disposed on the outer surface M2 of the positive electrode current collector 11a. As the positive electrode tab 30 is disposed on the outer surface M2 of the positive electrode current collector 11a, when the positive electrode 11 is wound together with the negative electrode 12 and the separator 13, the positive electrode tab 30 is hardly peeled off from the positive electrode 11. The positive electrode tab 30 includes a tab root portion 31 and a tab projecting portion 32.

The tab root portion 31 is disposed on the exposed portion 11al of the positive electrode current collector 11a and is electrically connected to the positive electrode current collector 11a.

The tab projecting portion 32 is continuous from the tab root portion 31. That is, the tab projecting portion 32 and the tab root portion 31 are integrated with each other. The tab projecting portion 32 is a portion projecting from the positive electrode current collector 11a in the positive electrode tab 30. Further, the tab projecting portion 32 projects from the wound body 10. The tab projecting portion 32 projects from the end surface S of the wound body 10 (FIG. 1), and is electrically connected to the lid portion 22. Note that in the present specification, a longitudinal direction of the tab projecting portion 32 corresponds to a direction in which the tab projecting portion 32 projects from the wound body 10.

As illustrated in FIG. 2, in the wound body 10, since the positive electrode tab 30 is sandwiched between two electrodes adjacent to each other in a radial direction of the wound body 10, a crescent-shaped first gap C1 may be formed in the vicinity of the positive electrode tab 30. Further, the positive electrode tab 30 is bent as illustrated in FIGS. 1 and 2 (details will be described later).

As illustrated in FIG. 1, the negative electrode tab 40 projects from the wound body 10. The negative electrode tab 40 electrically connects the negative electrode current collector and the main body 21 to each other.

The protective tape 50 protects the positive electrode tab 30. A material of the protective tape 50 has insulating properties, and is, for example, resin. As illustrated in FIG. 4, there are two protective tapes 50, and the protective tapes are attached to both surfaces of the positive electrode 11 so as to cover the positive electrode tab 30. A width of the protective tape 50 is larger than those of the positive electrode tab 30 and the exposed portion 11a1. The protective tape 50 includes a tape root portion 51 and a tape projecting portion 52.

The tape root portion 51 covers the tab root portion 31 and the positive electrode current collector 11a. Specifically, the tape root portion 51 is disposed on the positive electrode 11 so as to cover the tab root portion 31 and the exposed portion 11al of the positive electrode current collector 11a. Specifically, the tape root portion 51 of one protective tape 50 of the two protective tapes 50 is disposed on the inner surface M1 of the positive electrode current collector 11a, and the tape root portion 51 of the other protective tape 50 is disposed on the outer surface M2 of the positive electrode current collector 11a.

The tape root portion 51 is directly attached to the tab root portion 31 and the exposed portion 11al of the positive electrode current collector 11a. The tape root portion 51 is attached so as to cover a part of the positive electrode mixture layer 11b.

As illustrated in FIG. 4, in the vicinity of the positive electrode tab 30 and in the vicinity of an end portion of the positive electrode mixture layer 11b, there is a second gap C2 between the tape root portion 51 and the positive electrode 11. As described above, the tape root portion 51 is directly attached to the tab root portion 31 and the exposed portion 11al of the positive electrode current collector 11a, and the second gap C2 is relatively small. Therefore, mixing of foreign matter into the second gap C2 is suppressed in a manufacturing process of the secondary battery 1.

The tape projecting portion 52 is continuous with the tape root portion 51. That is, the tape projecting portion 52 and the tape root portion 51 are integrated with each other. Tape projecting portions 52 of the two protective tapes 50 are attached to each other with the tab projecting portion 32 interposed therebetween.

The tape projecting portion 52 is a portion projecting from the positive electrode current collector 11a in the protective tape 50. The tape projecting portion 52 projects from the wound body 10. Specifically, the tape projecting portion 52 projects from the end surface S of the wound body 10. The tape projecting portion 52 covers a portion on a base end side of the tab projecting portion 32.

The tape projecting portion 52 includes a first partial projecting portion 52a and a plurality of second partial projecting portions 52b. The first partial projecting portion 52a and the plurality of second partial projecting portions 52b are connected to each other on a base end side of the tape projecting portion 52.

The first partial projecting portion 52a extends in the longitudinal direction of the tab projecting portion 32 and covers the tab projecting portion 32. A width of the first partial projecting portion 52a is larger than that of the tab projecting portion 32. First partial projecting portions 52a of the two protective tapes 50 are attached to each other on both sides in a width direction of the tab projecting portion 32.

The plurality of second partial projecting portions 52b extend in the longitudinal direction of the tab projecting portion 32 and do not cover the tab projecting portion 32.

As illustrated in FIGS. 1 and 2, the tab projecting portion 32 and the tape projecting portion 52 (the first partial projecting portion 52a and the plurality of second partial projecting portions 52b) are bent at base end portions thereof toward a central portion of the end surface S along the end surface S of the wound body 10. Further, as illustrated in FIG. 2, the tab projecting portion 32, the first partial projecting portion 52a, and the plurality of second partial projecting portions 52b are bent so as to overlap a central portion of the wound body 10 in a top view of the wound body 10. The first partial projecting portion 52a and the plurality of second partial projecting portions 52b overlap each other in a bent state.

As the tab projecting portion 32, the first partial projecting portion 52a, and the plurality of second partial projecting portions 52b are bent in this manner, the first gap C1 in the vicinity of the positive electrode tab 30 is covered with the tab projecting portion 32, the first partial projecting portion 52a, and the plurality of second partial projecting portions 52b. Thus, mixing of foreign matter into the first gap C1 is suppressed in the manufacturing process of the secondary battery 1. In addition, as described above, the mixing of foreign matter into the second gap C2 is suppressed. Therefore, it is possible to suppress a short circuit inside the wound body 10 caused by the mixing of foreign matter into the wound body 10. Therefore, voltage drop of the secondary battery 1 can be suppressed.

As illustrated in FIG. 2, the first partial projecting portion 52a and the plurality of second partial projecting portions 52b are bent in directions different from each other. Thus, occurrence of wrinkles in the first partial projecting portion 52a and the plurality of second partial projecting portions 52b is suppressed, and undulations of the first partial projecting portion 52a and the plurality of second partial projecting portions 52b are suppressed. Therefore, it is possible to suppress an increase in the first gap C1 due to the wrinkles and undulations of the first partial projecting portion 52a and the plurality of second partial projecting portions 52b.

Furthermore, the wrinkles and undulations of the tape projecting portion 52 are suppressed, so that the tape projecting portion 52 can be easily bent. Therefore, an assembly failure of the secondary battery 1 can be suppressed. Further, as the wrinkles and undulations of the tape projecting portion 52 are suppressed, a space between the wound body 10 and the lid portion 22 can be effectively utilized inside the exterior body 20.

Next, regarding the manufacturing process of the secondary battery 1, a process of forming the first partial projecting portion 52a and the plurality of second partial projecting portions 52b in the tape projecting portion 52 will be described.

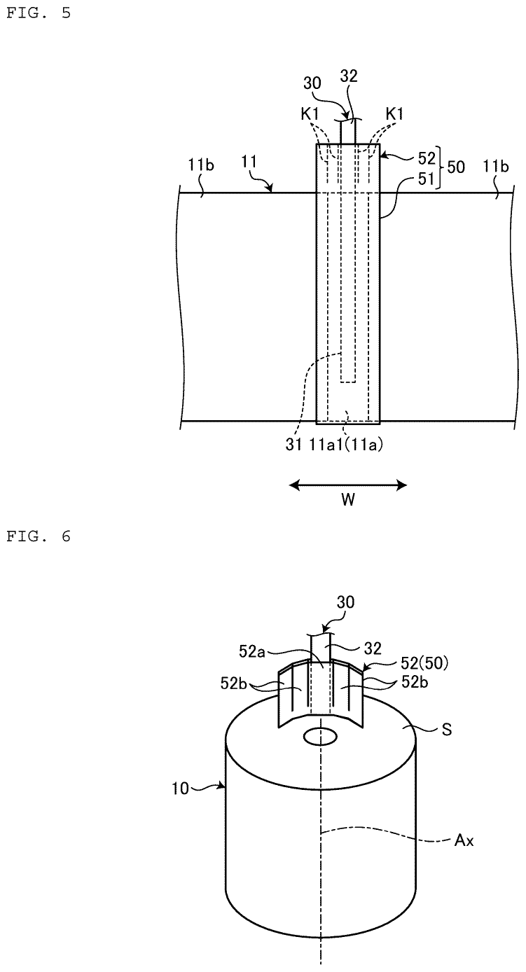

FIG. 5 is a plan view of the positive electrode 11 to which the protective tape 50 having the tape projecting portion 52 is attached before the positive electrode tab 30, the first partial projecting portion 52a, and the plurality of second partial projecting portions 52b are formed.

The positive electrode tab 30 and the two protective tapes 50 are attached to the positive electrode 11 in this order. Subsequently, a cut K1 is made in the tape projecting portion 52 in the longitudinal direction of the tab projecting portion 32 as shown by a broken line. The cut K1 is separated from the positive electrode 11 and the positive electrode tab 30. As illustrated in FIG. 3, the first partial projecting portion 52a and the plurality of second partial projecting portions 52b are formed in the tape projecting portion 52 by the cut K1. As described above, the tape projecting portion 52 is divided into the first partial projecting portion 52a and the plurality of second partial projecting portions 52b by a plurality of the cuts K1.

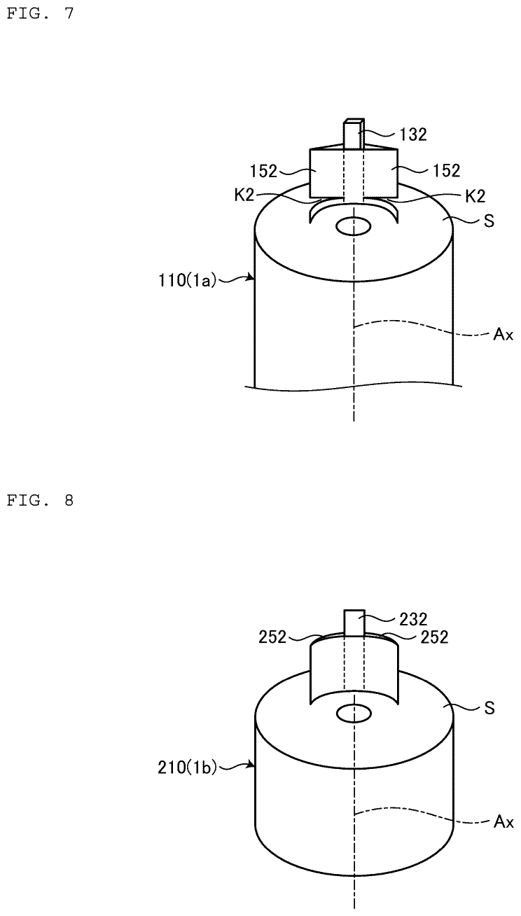

FIG. 6 is a perspective view of the wound body 10 showing a state where the positive electrode tab 30, the first partial projecting portion 52a, and the plurality of second partial projecting portions 52b are not bent.

The wound body 10 illustrated in FIG. 6 is formed by stacking and winding the positive electrode 11 and the negative electrode 12 illustrated in FIG. 3 with the separator 13 interposed therebetween. In the wound body 10 illustrated in FIG. 6, the tab projecting portion 32, the first partial projecting portion 52a, and the plurality of second partial projecting portions 52b are bent toward the central portion of the wound body 10, whereby the wound body 10 illustrated in FIG. 2 is formed.

Next, secondary batteries 1a, 1b, and 1c of three Comparative Examples will be described mainly in terms of a difference from the secondary battery 1 of the first embodiment.

FIG. 7 is a perspective view of a wound body 110 included in a secondary battery 1a according to Comparative Example 1. The wound body 110, a tab projecting portion 132, and a tape projecting portion 152 of Comparative Example 1 illustrated in FIG. 7 correspond to the wound body 10, the tab projecting portion 32, and the tape projecting portion 52 of the first embodiment.

The secondary battery 1a of Comparative Example 1 is different from the secondary battery 1 of the first embodiment in that a cut K2 of the tape projecting portion 152 is in a width direction of the tape projecting portion 52. Two cuts K2 of the tape projecting portion 152 of Comparative Example 1 are formed on opposite sides to each other with the tab projecting portion 132 interposed therebetween. The tab projecting portion 132 and the tape projecting portion 152 are bent at a portion between the two cuts K2 toward the central portion of the end surface S of the wound body 110.

The tape projecting portion 152 of Comparative Example 1 hardly covers the first gap C1 as compared with the tape projecting portion 52 of the first embodiment. Therefore, the secondary battery 1 of the first embodiment can suppress the mixing of foreign matter into the first gap C1 compared to the secondary battery 1a of Comparative Example 1, and can suppress the voltage drop of the secondary battery 1.

FIG. 8 is a perspective view of a wound body 210 included in a secondary battery 1b according to Comparative Example 2. The wound body 210, a tab projecting portion 232, and a tape projecting portion 252 of Comparative Example 2 illustrated in FIG. 8 correspond to the wound body 10, the tab projecting portion 32, and the tape projecting portion 52 of the first embodiment.

The secondary battery 1b of Comparative Example 2 is different from the secondary battery 1 of the first embodiment in that the tape projecting portion 252 does not include portions corresponding to the first partial projecting portion 52a and the plurality of second partial projecting portions 52b. That is, in the secondary battery 1b of Comparative Example 2, the tape projecting portion 252 is not cut. Therefore, a width of the tape projecting portion 252 is larger than those of the first partial projecting portion 52a and the second partial projecting portion 52b.

Therefore, when the tab projecting portion 232 and the tape projecting portion 252 of Comparative Example 2 are bent at base end portions thereof toward the central portion of the end surface S of the wound body 10, the wrinkles and undulations easily occur in the tape projecting portion 252 of Comparative Example 2 as compared with the tape projecting portion 52 of the first embodiment. Thus, the first gap C1 may increase in the wound body 210 of Comparative Example 2.

When the first gap C1 increases, the possibility that foreign matter is mixed into the wound body 210 from the first gap C1 increases. Therefore, the secondary battery 1 of the first embodiment can suppress the mixing of foreign matter into the first gap C1 compared to the secondary battery 1b of Comparative Example 2, and can suppress the voltage drop of the secondary battery 1.

When the wrinkles and undulations occur in the tape projecting portion 252 of Comparative Example 2, there is a possibility that the tape projecting portion 252 cannot be appropriately bent. In this case, the assembly failure of the secondary battery 1 may occur.

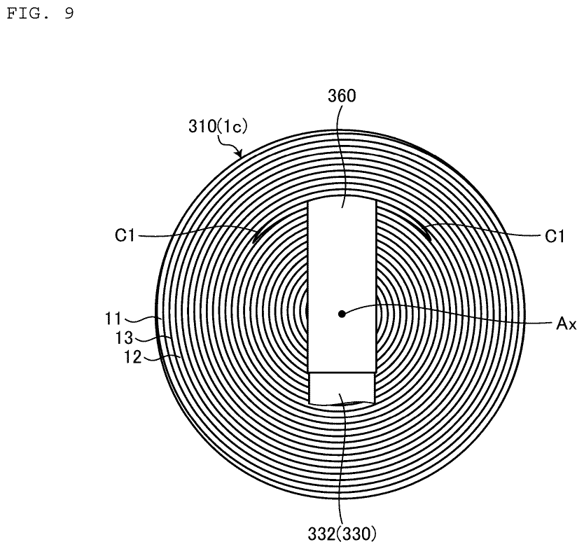

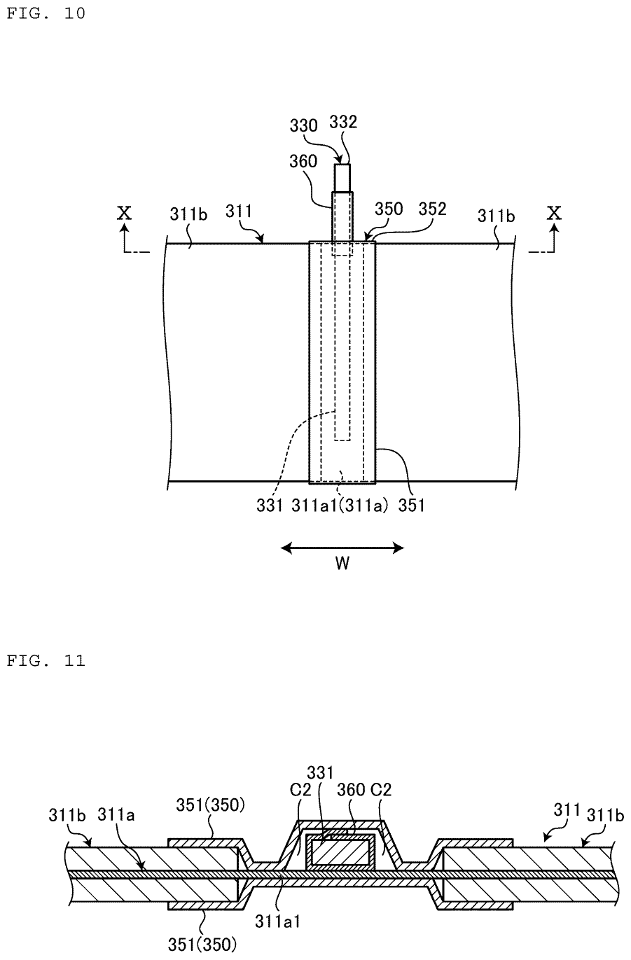

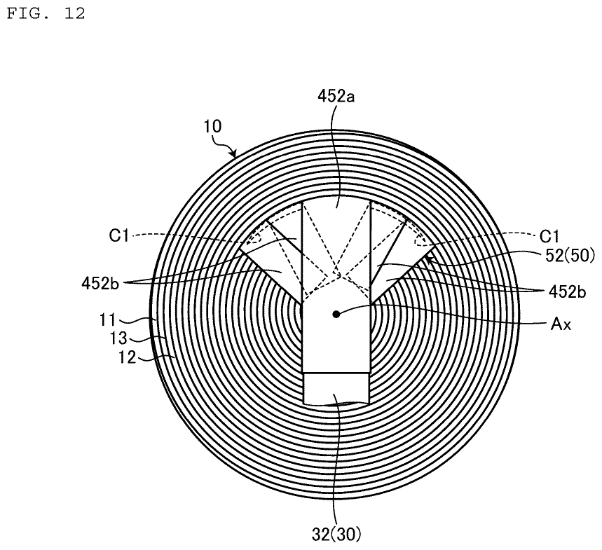

FIG. 9 is a top view of a wound body 310 included in a secondary battery 1c according to Comparative Example 3. FIG. 10 is a plan view of a positive electrode 311 included in the wound body 310 illustrated in FIG. 9. FIG. 11 is a sectional view of the positive electrode 311 taken along line X-X illustrated in FIG. 10. The wound body 310, the positive electrode 311, a positive electrode tab 330 (a tab root portion 331 and a tab projecting portion 332), and a protective tape 350 (a tape root portion 351 and a tape projecting portion 352) of Comparative Example 3 illustrated in FIGS. 9, 10, and 11 correspond to the wound body 10, the positive electrode 11, the positive electrode tab 30 (the tab root portion 31 and the tab projecting portion 32),
and the protective tape 50 (the tape root portion 51 and the tape projecting portion 52) of the first embodiment.

A positive electrode current collector 311a, an exposed portion 311a1, and the positive electrode mixture layer 311b illustrated in FIGS. 10 and 11 correspond to the positive electrode current collector 11a, the exposed portion 11al, and the positive electrode mixture layer 11b of the first embodiment.

In the secondary battery 1c of Comparative Example 3, a length in the longitudinal direction of the tape projecting portion 352 is extremely smaller than that in the longitudinal direction of the tape projecting portion 52 of the first embodiment. The tape projecting portion 352 has no cut K1, and does not have portions corresponding to the first partial projecting portion 52a and the plurality of second partial projecting portions 52b. Note that in the secondary battery 1c of Comparative Example 3, the protective tape 350 may not have the tape projecting portion 352.

As illustrated in FIGS. 9, 10, and 11, the secondary battery 1c of Comparative Example 3 further includes a covering tape 360 covering a portion on a base end side of the tab projecting portion 332. The covering tape 360 is wound around the positive electrode tab 30. As illustrated in FIGS. 10 and 11, the covering tape 360 overlaps the tape projecting portion 352.

The covering tape 360 overlaps an end portion of the tape root portion 351 continuous from the tape projecting portion 352. Therefore, as illustrated in FIG. 11, at the end portion of the tape root portion 351, the positive electrode tab 330 is attached to the exposed portion 311al with the covering tape 360 interposed therebetween by the protective tape 50. Therefore, the second gap C2 of Comparative Example 3 is larger than the second gap C2 of the first embodiment.

The covering tape 360 of Comparative Example 3 is bent at the base end portion toward the central portion of the end surface S of the wound body 310. The tape projecting portion 352 of Comparative Example 3 is not bent. As illustrated in FIG. 9, also when the covering tape 360 is bent, the covering tape 360 cannot cover the first gap C1.

Therefore, the secondary battery 1 of the first embodiment can suppress the mixing of foreign matter into the first gap C1 and the second gap C2 compared to the secondary battery 1c of Comparative Example 3, and can suppress the voltage drop of the secondary battery 1.

Next, the secondary battery 1 according to a second embodiment of the present disclosure will be described mainly in terms of a difference from the secondary battery 1 of the first embodiment.

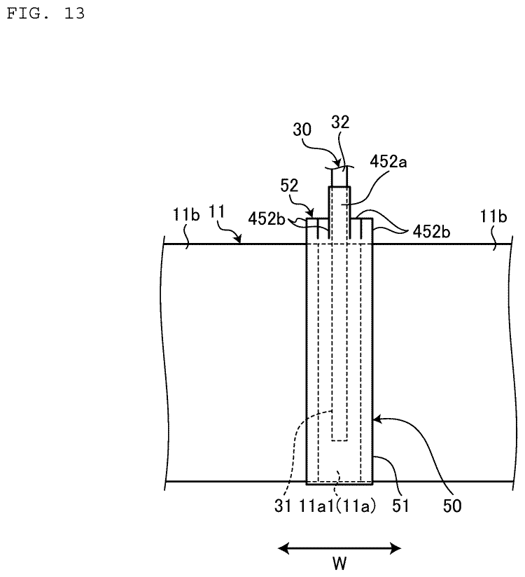

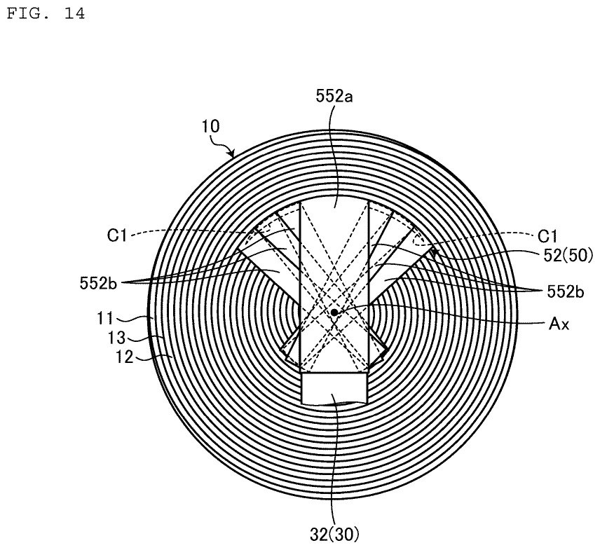

FIG. 12 is a top view of the wound body 10 included in the secondary battery 1 according to the second embodiment of the present disclosure. FIG. 13 is a plan view of the positive electrode 11 included in the wound body 10 illustrated in FIG. 12.

The secondary battery 1 of the second embodiment is different from the secondary battery 1 of the first embodiment in that a length in a longitudinal direction of a first partial projecting portion 452a of the tape projecting portion 52 is longer than that of a second partial projecting portion 452b. Thus, it is possible to suppress a size of a range in which a plurality of the second partial projecting portions 452b overlap each other in a state where the plurality of second partial projecting portions 452b are bent as illustrated in FIG. 12. Therefore, a thickness of the tape projecting portion 52 is suppressed in a range where the plurality of second partial projecting portions 452b overlap each other. Therefore, the space between the wound body 10 and the lid portion 22 can be effectively utilized inside the exterior body 20.

Next, the secondary battery 1 according to a third embodiment of the present disclosure will be described mainly in terms of a difference from the secondary battery 1 of the first embodiment.

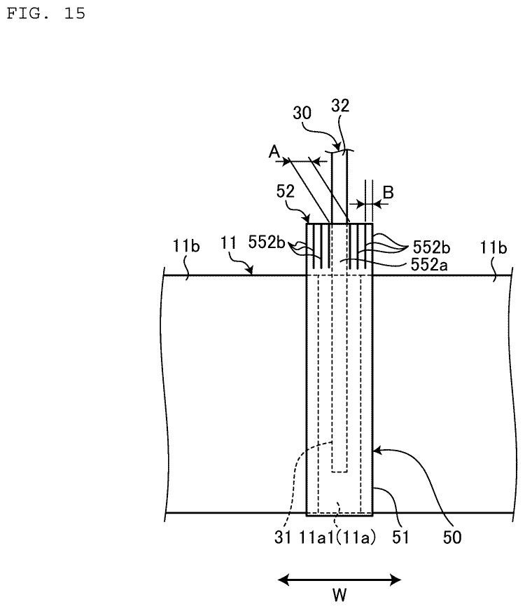

FIG. 14 is a top view of the wound body 10 included in the secondary battery 1 according to the third embodiment of the present disclosure. FIG. 15 is a plan view of the positive electrode 11 included in the wound body 10 illustrated in FIG. 14.

The secondary battery 1 of the third embodiment is different from the secondary battery 1 of the first embodiment in that a width (a length A illustrated in FIG. 15) of a first partial projecting portion 552a is larger than a width (a length B illustrated in FIG. 15) of a second partial projecting portion 552b. That is, the width of the second partial projecting portion 552b is smaller than that of the first partial projecting portion 552a. Thus, it is possible to further suppress the wrinkles occurring in the second partial projecting portion 552b. Therefore, the increase in the first gap C1 can be further suppressed. Therefore, the mixing of foreign matter into the first gap C1 is further suppressed, and the voltage drop of the secondary battery 1 can be further suppressed.

Next, the secondary battery 1 according to a fourth embodiment of the present disclosure will be described mainly in terms of a difference from the secondary battery 1 of the first embodiment.

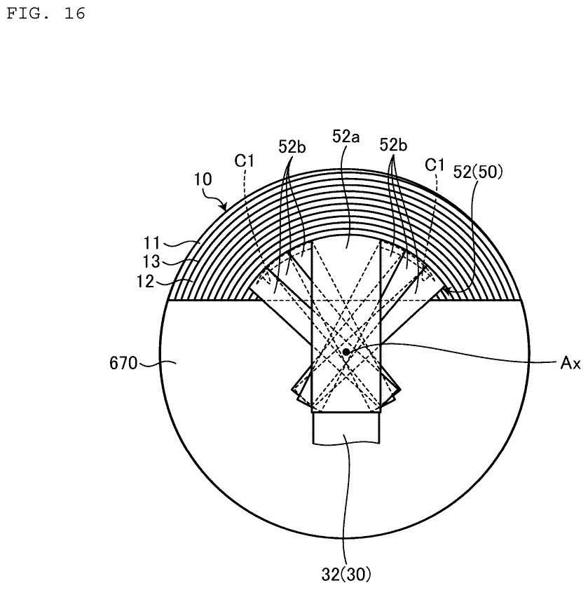

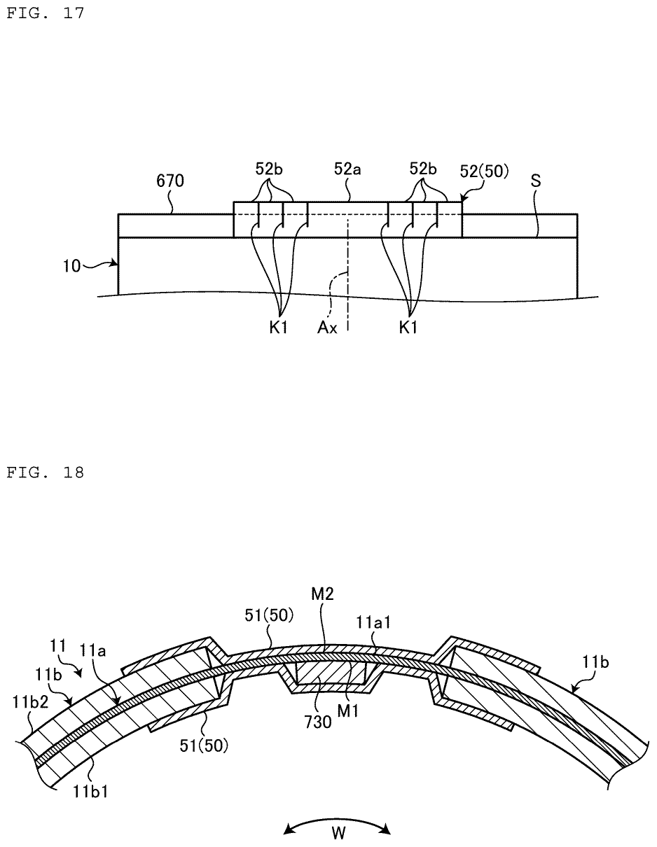

FIG. 16 is a top view of the wound body 10 included in the secondary battery 1 according to the fourth embodiment of the present disclosure. FIG. 17 is an enlarged side view of a portion of the wound body 10 illustrated in FIG. 16.

The secondary battery 1 of the fourth embodiment is different from the secondary battery 1 of the first embodiment in further including an insulating plate 670. As illustrated in FIGS. 16 and 17, the insulating plate 670 is disposed on the end surface S of the wound body 10 to electrically insulate the negative electrode 12 from the positive electrode tab 30.

The insulating plate 670 has a shape separated from the base end of the tab projecting portion 32 and the base end of the tape projecting portion 52 in a top view of the wound body 10. The insulating plate 670 is between the first partial projecting portion 52a and the plurality of second partial projecting portions 52b, which are bent, and the end surface S of the wound body 10 in a state where the first partial projecting portion 52a and the plurality of second partial projecting portions 52b are bent.

In a side view of the wound body 10 illustrated in FIG. 17, the first partial projecting portion 52a and the plurality of second partial projecting portions 52b overlap the insulating plate 670. In other words, in a side view of the wound body 10, the cut K1 of the tape projecting portion 52 overlaps the insulating plate 670. Thus, the first partial projecting portion 52a and the plurality of second partial projecting portions 52b can be easily bent. Therefore, an assembly failure of the secondary battery 1 can be suppressed.

Furthermore, when the first partial projecting portion 52a and the plurality of second partial projecting portions 52b overlap the insulating plate 670 in a side view of the wound body 10, the wrinkles occurring in the tape projecting portion 52 can be suppressed as compared with a case where the first partial projecting portion 52a and the plurality of second partial projecting portions 52b are separated from the insulating plate 670 due to a relatively short cut K1 of the tape projecting portion 52. Therefore, the increase in the first gap C1 can be suppressed, the assembly failure of the secondary battery 1 can be suppressed, and the space between the wound body 10 and the lid portion 22 can be effectively utilized inside the exterior body 20.

Next, the secondary battery 1 according to a fifth embodiment of the present disclosure will be described mainly in terms of a difference from the secondary battery 1 of the first embodiment.

FIG. 18 is a sectional view of the positive electrode 11 included in the secondary battery 1 according to the fifth embodiment of the present disclosure.

The secondary battery 1 of the fifth embodiment is different from the secondary battery 1 of the first embodiment in that a positive electrode tab 730 is disposed on the inner surface M1 of the positive electrode current collector 11a. As the positive electrode tab 730 is disposed on the inner surface M1 of the positive electrode current collector 11a, the positive electrode 11 can be easily wound. Specifically, since the positive electrode tab 730 is on the inner surface M1, the positive electrode 11 is easily bent in the winding direction W. Thus, a size of the first gap C1 can be suppressed. Therefore, the mixing of foreign matter into the first gap C1 is suppressed, and the voltage drop of the secondary battery 1 can be suppressed.

### <Voltage Failure Test, Productivity Test, and Test Results>

Table 1 shows test results of a voltage failure test and a productivity test for the secondary batteries 1 of the above embodiments and the secondary batteries 1a, 1b, and 1c of Comparative Examples.

TABLE 1

| | Voltage failure test | Productivity test |
|---|---|---|
| Secondary battery 1a of | 2 | OK |
| Comparative Example 1 | | |
| Secondary battery 1b of | 1 | NG |
| Comparative Example 2 | | |
| Secondary battery 1c of | 4 | OK |
| Comparative Example 3 | | |
| Secondary battery 1 of | 0 | OK |
| first embodiment | | |
| Secondary battery 1 of | 0 | OK |
| second embodiment | | |
| Secondary battery 1 of | 0 | OK |
| third embodiment | | |
| Secondary battery 1 of | 0 | OK |
| fourth embodiment | | |
| Secondary battery 1 of | 0 | OK |
| fifth embodiment | | |

### <Voltage Failure Test>

In the voltage failure test, for the secondary batteries 1 of the embodiments and the secondary batteries 1a, 1b, and 1c of Comparative Examples, it is confirmed whether the voltage drop occurs due to the mixing of foreign matter into the first gap C1 and the second gap C2.

In the manufacturing process of the secondary batteries 1 of the above embodiments and the secondary batteries 1a, 1b, and 1c of Comparative Examples used in the voltage failure test, metal powder of a predetermined size is charged into the exterior body 20 together with the electrolyte in a state where the wound body 10 (FIG. 6) before the tab projecting portion 32, the first partial projecting portion 52a, and the plurality of second partial projecting portions 52b are bent is housed in the main body 21 of the exterior body 20. That is, in the secondary battery 1 used in the voltage failure test, the metal powder is intentionally charged into the exterior body 20 as foreign matter.

In the voltage failure test, first, the secondary batteries 1, 1a, 1b, and 1c are charged until fully charged. Subsequently, the secondary batteries 1, 1a, 1b, and 1c are left standing for 48 hours. When the voltage drop is 50 mV or more after standing for 48 hours, it is determined that there is a voltage drop.

A column corresponding to the voltage failure test in Table 1 shows the number of secondary batteries which are determined to have a voltage drop when the voltage failure test was performed on 10 secondary batteries 1 of the embodiments and 10 secondary batteries 1a, 1b, and 1c of Comparative Examples.

As shown in Table 1, in the secondary battery 1a of Comparative Example 1, it was determined that there was a voltage drop in two of the 10 secondary batteries 1a. In the secondary battery 1a of Comparative Example 1 illustrated in FIG. 7, it is considered that the tape projecting portion 152 could not appropriately cover the first gap C1, and foreign matter was mixed into the first gap C1.

In the secondary battery 1b of Comparative Example 2, it was determined that there was a voltage drop in one of the 10 secondary batteries 1b. In the secondary battery 1b of Comparative Example 2 illustrated in FIG. 8, it is considered that the first gap C1 is enlarged by the wrinkles and undulations of the tape projecting portion 252, and foreign matter is mixed into the first gap C1.

Further, in the secondary battery 1c of Comparative Example 3, it was determined that there was a voltage drop in four of the 10 secondary batteries 1c. In the secondary battery 1c of Comparative Example 3 illustrated in FIG. 9, the second gap C2 is larger than that of the secondary battery 1 of the first embodiment, and it is considered that the covering tape 360 cannot appropriately cover the first gap C1, and foreign matter is mixed into the first gap C1 and the second gap C2.

In the secondary batteries 1 of five embodiments from the first embodiment to the fifth embodiment, it was determined that there was a voltage drop in 0 of the 10 secondary batteries 1. That is, it was determined that there was no voltage drop in the secondary batteries 1 of the five embodiments from the first embodiment to the fifth embodiment. In the secondary batteries 1 of the five embodiments from the first embodiment to the fifth embodiment, it is considered that the tape projecting portion 52 appropriately covers the first gap C1, the second gap C2 is relatively small, and the mixing of foreign matter into the first gap C1 and the second gap C2 is suppressed.

### <Productivity Test>

The productivity test is a test for confirming a distance D illustrated in FIG. 1 for the secondary batteries 1 of the embodiments and the secondary batteries 1a, 1b, and 1c of Comparative Examples. The distance D is a length from an end surface of the main body 21 to a bent portion of the tape projecting portion 52.

When the tape projecting portion 52 is bent, as the wrinkles and undulations occurring in the tape projecting portion 52 are larger, the distance D is smaller, and possibility of occurrence of the assembly failure of the secondary battery 1 increases. In the productivity test, when the distance D is larger than a predetermined length, it is determined that there is no problem in assembling the secondary battery 1. On the other hand, when the distance D is equal to or less than the predetermined length, it is determined that there is a problem in assembling the secondary battery 1. The predetermined length is determined by experiments or the like.

A column corresponding to the productivity test in Table 1 shows “OK” indicating that there is no problem in assembly of the secondary battery 1 or “NG” indicating that there is a problem in the assembly of the secondary battery 1.

As shown in Table 1, in the secondary battery 1b of Comparative Example 2 illustrated in FIG. 8, it was determined that there was a problem in assembling the secondary battery 1b. As described above, the wrinkles and undulations are likely to occur in the tape projecting portion 252 of the secondary battery 1b of Comparative Example 2. Thus, it is considered that the distance D has become equal to or shorter than the predetermined length.

On the other hand, in the secondary batteries 1a and 1c of Comparative Examples 1 and 3 and the secondary batteries 1 of the five embodiments from the first embodiment to the fifth embodiment, it was determined that there was no problem in assembling the secondary battery 1. In the secondary batteries 1a and 1c of Comparative Examples 1 and 3 and the secondary batteries 1 of the embodiments, it is considered that the wrinkles and undulations hardly occur in the tape projecting portion 52, and the distance D has become longer than the predetermined length.

As described above, the secondary batteries 1 of the five embodiments from the first embodiment to the fifth embodiment have achieved good results in both the voltage failure test and the productivity test.

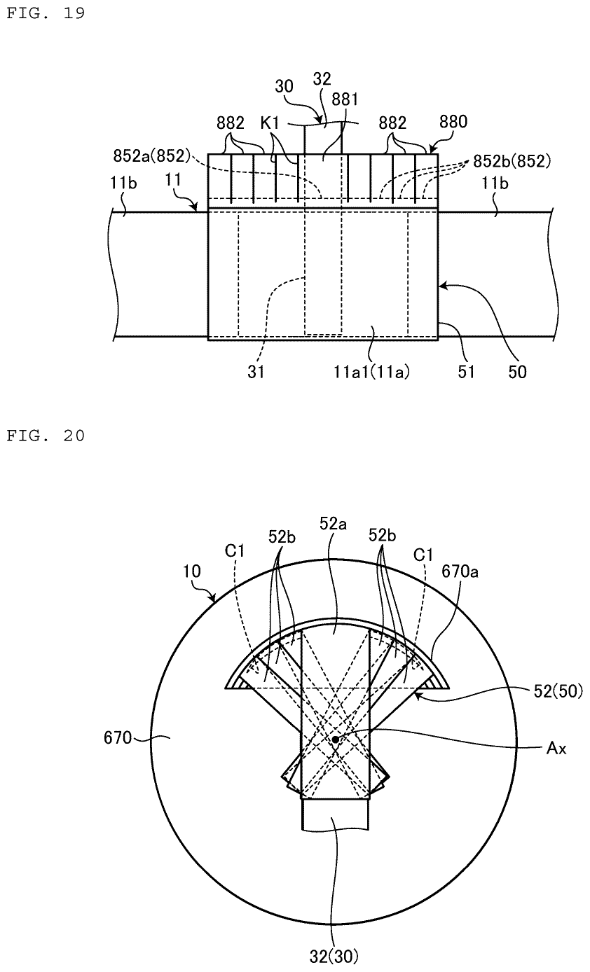

FIG. 19 is a plan view of the positive electrode 11 included in the secondary battery 1 according to a modification of the first embodiment of the present disclosure. In the secondary battery 1 of the present modification, a length in a longitudinal direction of a tape projecting portion 852 is shorter than that in the longitudinal direction of the tape projecting portion 52 of the first embodiment.

The secondary battery 1 of the present modification further includes a second protective tape 880. There are two second protective tapes 880. The two second protective tapes 880 are attached to each other with a tip of the tape projecting portion 852 and the tab projecting portion 32 interposed therebetween.

The second protective tape 880 has a first partial tape portion 881 and a plurality of second partial tape portions 882. The first partial tape portion 881 and the plurality of second partial tape portions 882 correspond to a first partial projecting portion 852a and a plurality of second partial projecting portions 852b.

When the second protective tape 880 is attached to the tape projecting portion 852 of the protective tape 50 in which the cut K1 is not made, and the cut K1 is made in the tape projecting portion 852 and the second protective tape 880, the first partial projecting portion 852a and the plurality of second partial projecting portions 852b, and the first partial tape portion 881 and the plurality of second partial tape portions 882 are formed.

In the present modification, the first gap C1 is covered by bending the first partial tape portion 881 and the plurality of second partial tape portions 882. Therefore, the voltage drop of the secondary battery 1 can be suppressed as in the first embodiment.

Note that in the present modification, the tape projecting portion 852 may not have the first partial projecting portion 852a and the plurality of second partial projecting portions 852b. In this case, the tape projecting portion 852 is not provided with the cut K1.

FIG. 20 is a top view of the wound body 10 included in the secondary battery 1 according to the modification of the fourth embodiment of the present disclosure. The secondary battery 1 of the present modification is different from the secondary battery 1 of the fourth embodiment in that the insulating plate 670 has a shape having a through-hole 670a surrounding the tab projecting portion 32 and the tape projecting portion 52. The tab projecting portion 32 and the tape projecting portion 52 pass through the through-hole 670a.

Also in the secondary battery 1 of the present modification, similarly to the secondary battery 1 of the fourth embodiment, the first partial projecting portion 52a and the plurality of second partial projecting portions 52b are bent. Therefore, also in the secondary battery 1 of the present modification, similarly to the secondary battery 1 of the fourth embodiment, the increase in the first gap C1 can be suppressed, the assembly failure of the secondary battery 1 can be suppressed, and the space between the wound body 10 and the lid portion 22 can be effectively utilized inside the exterior body 20.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a wound body in which a positive electrode having a positive electrode current collector and a negative electrode are stacked and wound;
an exterior body in which the wound body is housed;
a positive electrode tab electrically connecting the positive electrode current collector and the exterior body to each other; and
a protective tape attached to the positive electrode so as to cover the positive electrode tab, wherein
the positive electrode tab includes:
a tab root portion disposed on the positive electrode current collector; and
a tab projecting portion continuous from the tab root portion and projecting from the wound body,
the protective tape includes:
a tape root portion covering the tab root portion and the positive electrode current collector; and
a tape projecting portion continuous from the tape root portion and projecting from the wound body,
the tape projecting portion includes:
a first partial projecting portion extending in a longitudinal direction of the tab projecting portion and covering the tab projecting portion; and
a plurality of second partial projecting portions extending in the longitudinal direction of the tab projecting portion and not covering the tab projecting portion, and
the tab projecting portion, the first partial projecting portion, and the plurality of second partial projecting portions are bent.

2. The secondary battery according to claim 1, wherein the tab projecting portion, the first partial projecting portion, and the plurality of second partial projecting portions are bent in different directions.

3. The secondary battery according to claim 1, wherein the first partial projecting portion and the plurality of second partial projecting portions overlap each other in a bent state.

4. The secondary battery according to claim 3, wherein the first partial projecting portion and the plurality of second partial projecting portions overlap a central portion of the wound body in a top view of the wound body.

5. The secondary battery according to claim 1, wherein a longitudinal length of the first partial projecting portion is longer than a longitudinal length of the second partial projecting portion.

6. The secondary battery according to claim 1, wherein a width of the first partial projecting portion is larger than a width of the second partial projecting portion.

7. The secondary battery according to claim 1, comprising an insulating plate disposed on an end surface of the wound body, wherein
the first partial projecting portion and the plurality of second partial projecting portions overlap the insulating plate in a side view of the wound body.

8. The secondary battery according to claim 1, wherein
the positive electrode current collector includes an inner surface on a radially inner side of the wound body and an outer surface on a radially outer side of the wound body, and
the positive electrode tab is disposed on the inner surface.
